(19) United States
(12) Patent Application Publication
(10) Pub. No.: US 2010/0042870 A1
(43) Pub. Date: Feb. 18, 2010

(54) MULTICORE PROCESSOR AND METHOD OF CONTROLLING MULTICORE PROCESSOR

(75) Inventor: Takanao AMATSUBO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/536,910

(22) Filed: Aug. 6, 2009

(30) Foreign Application Priority Data
Aug. 12, 2008 (JP) 2008-208021

(51) Int. Cl. G06F 9/00; G06F 15/76; G06F 9/06; G06F 11/07

(52) U.S. Cl. 714/10; 712/30; 713/100; 712/E09.003; 714/E11.023; 714/30

(57) ABSTRACT

A multicore processor has a plurality of processor cores each of which is configured to execute a computation, a plurality of reconfigurable devices dynamically reconfigurable in circuit configuration on the basis of circuit information, and a lock state storage section configured to store lock information indicating whether or not each of the reconfigurable devices is locked. The multicore processor also has a plurality of reconfigurable control sections each of which is configured to load circuit information for a computation to be executed into one of the reconfigurable devices not locked, by referring to the lock information, performs execution of the computation with the reconfigurable device and execution of the computation with the one of the processor cores in parallel with each other, and perform control so that results of execution of the computation completed faster are adopted.

### CROSS-REFERENCE TO RELATED APPLICATION

This application is based upon and claims the benefit of priority from the prior Japanese Patent Application No. 2008-208021 filed in Japan on Aug. 12, 2008, the entire contents of which are incorporated herein by reference.

### BACKGROUND OF THE INVENTION

1. Field of the Invention

The present invention relates to a multicore processor and to a method of controlling the multicore processor. More particularly, the present invention relates to a multicore processor having a plurality of reconfigurable devices dynamically reconfigurable in circuit configuration and to a method of controlling the multicore processor.

2. Description of Related Art

Conventionally, a multicore processor having a plurality of processors in one chip is adopted to increase the processing performance of a computer. A processor apparatus incorporating the multicore processor is designed to improve the processing performance by running a plurality of programs on a plurality of processor cores in parallel with each other.

In recent years, hardware processing using hardware, i.e., processing using a special-purpose processing circuit adapted to predetermined processing to realize processing at a higher speed in comparison with software processing using a processor, has been performed. With use of a plurality of special-purpose processing circuits mounted in one chip in adaptation to predetermined processing, however, there is a problem that the circuit scale is increased. A reconfigurable device dynamically reconfigurable in circuit configuration is therefore being utilized in place of special-purpose processing circuits.

The circuit configuration of the reconfigurable device is reconfigured to perform a function on the basis of circuit information stored in an external storage device or the like, and the predetermined processing is executed by the reconfigured circuit. Use of the reconfigurable device eliminates the need for a plurality of special-purpose processing circuits and enables prevention of an increase in circuit scale.

An information processing system configured to have a programmable logic circuit reconfigurable in circuit configuration as described above has been proposed (see, for example, Japanese Patent Application Laid-Open Publication No. 2006-107532).

In the information processing system proposed, a function to perform processing based on software is incorporated together with reconfigurable hardware by considering a long time taken to reconfigure the hardware. The information processing system has selection condition setting means in which various selection condition items including processing times and amounts of memory consumption for software processing and hardware processing and times taken for reconfiguration of a programmable logic circuit are stored in advance. The selection condition setting means determines, by referring to one of the selection condition items or a combination of some of the selection condition items, which one of software processing and hardware processing is to be selected. In this way, in the information processing system, before execution of certain processing, determination as to through which one of software processing and hardware processing the execution of the processing can be completed faster can be made upon consideration of the time taken to reconfigure hardware.

However, the above-described proposed information processing system is incapable of complicated processing if it is impossible or difficult to determine in advance through which one of software processing and hardware processing the execution of the processing can be completed faster. The information processing system also has a problem in that a considerably long time is wasted for determining through which one of software processing and hardware processing certain processing can be performed faster, and a reduction in processing speed results.

### BRIEF SUMMARY OF THE INVENTION

According to one aspect of the present invention, there is provided a multicore processor including a plurality of processor cores each of which is configured to execute a computation based on a program, a plurality of reconfigurable devices each reconfigurable dynamically in circuit configuration on the basis of circuit information, a lock state storage section configured to store lock information indicating whether or not each of the reconfigurable devices is locked by one of the plurality of processor cores, and a plurality of reconfigurable control sections respectively provided in correspondence with the plurality of processor cores, each of the reconfigurable control sections configured to execute: determining whether or not circuit information for a computation to be executed is loaded in each of the reconfigurable devices, and if the circuit information for the computation to be executed is loaded, referring to the lock information, and performing only execution of the computation with the reconfigurable device in which the circuit information for the computation to be executed is loaded, without executing the computation to be executed in any of the plurality of processor cores, when the reconfigurable device in which the circuit information for the computation to be executed is loaded is not locked, and if the circuit information for the computation to be executed is not loaded, loading the circuit information for the computation to be executed in one of the reconfigurable devices not locked, by referring to the lock information, performing execution of the computation with the reconfigurable device in which the circuit information for the computation to be executed is loaded and execution of the computation with one of the plurality of processor cores in parallel with each other, and performing control so that results of the execution of the computation completed faster between results of the two executions of the computation performed in parallel with each other are adopted as results of the computation to be executed.

### BRIEF DESCRIPTION OF THE DRAWINGS

FIG. 1 is a block diagram showing a configuration of a multicore processor according to one embodiment of the present invention;

FIG. 2 is a diagram for explaining an example of a configuration of a lock state storage section;

FIG. 3 is a diagram for explaining an example of a program in which processing for setting a final execution bit to 1 is described;

FIG. 4 is a diagram for explaining an example of a configuration of a device state storage section;

FIG. 5 is a flowchart showing an example of a flow of processing for computations with reconfigurable devices;

FIG. 6 is a flowchart showing an example of a flow of loading of new circuit information in parallel with computation with one of the reconfigurable devices;

FIG. 7 is another flowchart showing an example of a flow of loading of new circuit information in parallel with computation with one of the reconfigurable devices; and

FIG. 8 is a flowchart showing an example of a flow of BIST processing.

### DETAILED DESCRIPTION OF THE EMBODIMENT OF THE INVENTION

An embodiment of the present invention will be described in detail below with reference to the accompanying drawings.

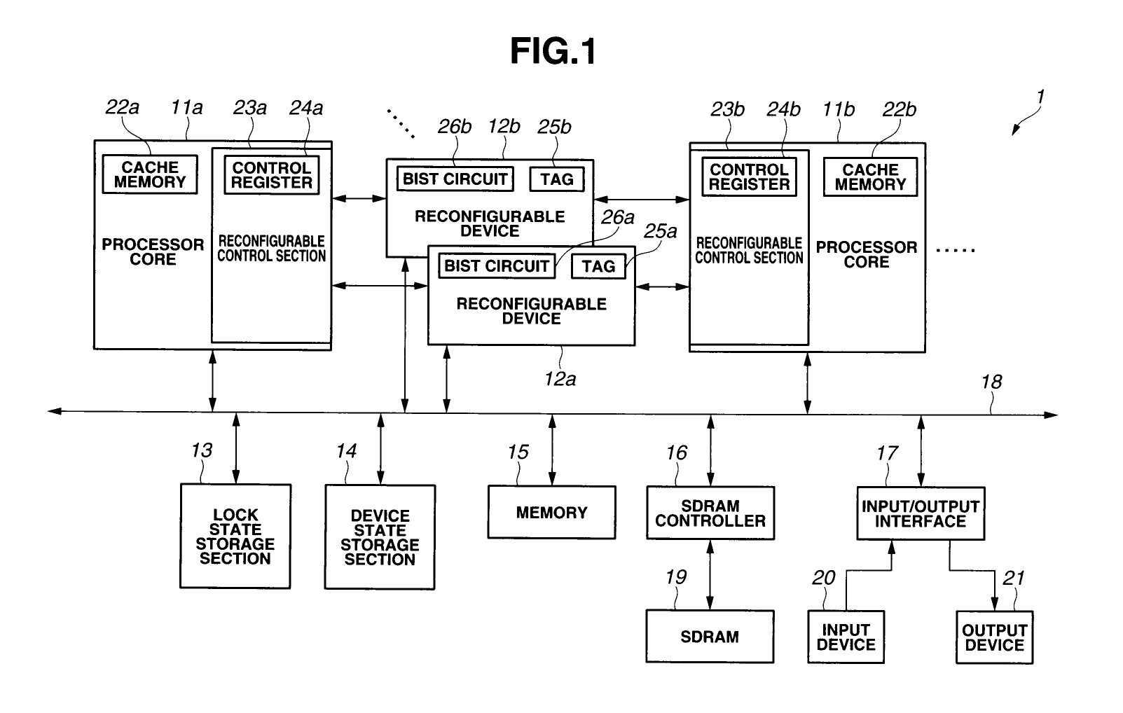

First, the configuration of a multicore processor according to one embodiment of the present invention will be described with reference to FIG. 1. FIG. 1 is a block diagram showing the configuration of a multicore processor according to one embodiment of the present invention.

As shown in FIG. 1, the multicore processor 1 has a configuration including a plurality of processor cores 11a and 11b, a plurality of reconfigurable devices 12a and 12b, a lock state storage section 13, a device state storage section 14, a memory 15 as an internal storage device, an SDRAM controller 16, an input/output interface 17 and a bus 18.

The plurality of processor cores 11a and 11b, the plurality of reconfigurable devices 12a and 12b, the lock state storage section 13, the device state storage section 14, the memory 15, the SDRAM controller 16 and the input/output interface 17 are connected to each other through the bus 18. An SDRAM 19 as an external storage device, an input device 20 and an output device 21 are provided outside the multicore processor 1. The SDRAM 19 is connected to the SDRAM controller 16. Each of the input device 20 and the output device 21 is connected to the input/output interface 17.

The multicore processor 1, having two processor cores 11a and 11b, may have three or more processor cores. Also, the multicore processor 1, having two reconfigurable devices 12a and 12b, may have three or more reconfigurable devices. That is, while FIG. 1 shows an example of the configuration in which the two processor cores 11a and 11b share two reconfigurable devices 12a and 12b, three or more processor cores may share three or more reconfigurable devices.

Each of the reconfigurable devices 12a and 12b is a device capable of dynamically reconfiguring its circuit configuration on the basis of circuit information. The circuit information is held in the memory 15 or the SDRAM 19.

The processor core 11a has a configuration including a cache memory 22a and a reconfigurable control section 23a. The reconfigurable control section 23a has a configuration including a control register 24a.

Similarly, the processor core 11b has a configuration including a cache memory 22b and a reconfigurable control section 23b. The reconfigurable control section 23b has a configuration including a control register 24b.

The reconfigurable device 12a has a configuration including a tag 25a and a BIST circuit 26a. Similarly, the reconfigurable device 12b has a configuration including a tag 25b and a BIST circuit 26b.

The processor core 11a executes a program stored in the memory 15 or the SDRAM 19 on the basis of a command from the input device 20. The processor core 11a reads (or fetches) an instruction from the program and stores the fetched instruction in the cache memory 22a.

The reconfigurable control section 23a monitors at all times an instruction fetched by the processor core 11a and determines whether or not the instruction can be executed by the reconfigurable device 12a or 12b. In the case of determining that the fetched instruction can be executed by the reconfigurable device 12a or 12b, the reconfigurable control section 23a checks whether or not corresponding circuit information has been loaded in the reconfigurable device 12a or 12b by referring to the tag 25a or 25b. Description will be made by assuming that circuit information has been loaded in the reconfigurable device 12a.

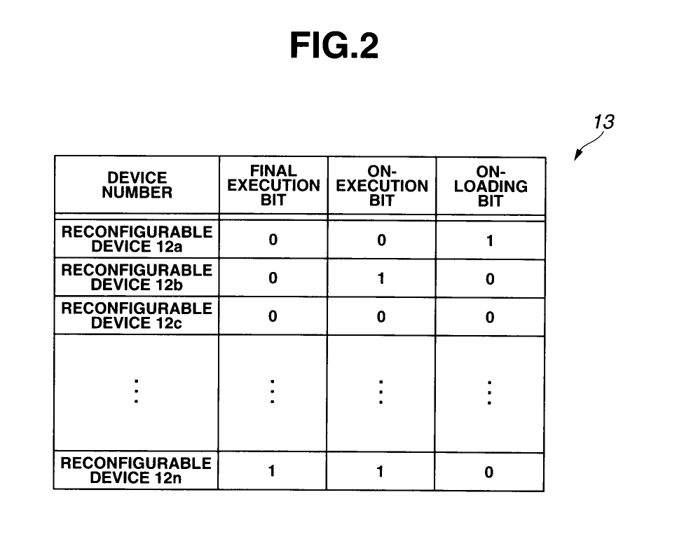

In a case where circuit information has been loaded in the reconfigurable device 12a, the reconfigurable control section 23a checks whether or not the reconfigurable device 12a having circuit information loaded therein is occupied by another processor core, e.g., the processor core 11b. The state of being occupied by the other processor core 11b is expressed as “locked.” Check as to whether or not the reconfigurable device 12a is occupied by the other processor core 11b is made by the reconfigurable control section 23a referring to the lock state storage section 13. The configuration of the lock state storage section 13 will be described later in detail with reference to FIG. 2.

If the reconfigurable device 12a is not occupied by the other processor core 11b, the processor core 11a performs only hardware processing with the reconfigurable device 12a without performing software processing. The processor core 11a may perform different software processing during execution with the reconfigurable device 12a.

In a case where no circuit information has been loaded in the reconfigurable device 12a or 12b, or in a case where circuit information has been loaded in the reconfigurable device 12a or 12b but the reconfigurable device 12a or 12b is occupied by the other processor core 11b, the reconfigurable control section 23a searches for the reconfigurable device not occupied by the other processor core 11b by referring to the lock state storage section 13. Description will be made by assuming that the reconfigurable device 12b is not occupied by the other processor core 11b.

In a case where the reconfigurable device 12b is not occupied by the other processor core 11b, that is, the reconfigurable device 12b is available, the reconfigurable control section 23a performs loading of circuit information into the reconfigurable device 12b and execution of hardware processing with the reconfigurable device 12b and execution of software processing with the processor core 11a in parallel with each other, and adopts the results of the processing completed faster. At the time of loading of circuit information, the reconfigurable control section 23a loads the circuit information after locking the reconfigurable device 12b and changing the reconfigurable device 12b from a low power consumption mode to a normal power consumption mode. If there is no available reconfigurable device, the reconfigurable control section 23a executes only software processing with the processor core 11a.

Each of the tags 25a and 25b is a register in which an identifier for a loaded computation circuit is stored. That is, in the tag 25a, an identifier for a computation circuit loaded in the reconfigurable device 12a is stored. In the tag 25b, an identifier for a computation circuit loaded in the reconfigurable device 12b is stored. For example, in a case where no loaded circuit information exists in the reconfigurable device 12a at the time of powering on, 0 is stored in the tag 25a. Also, in a case where information on a multiplication circuit has been loaded in the reconfigurable device 12a, 1 is stored in the tag 25a. The reconfigurable control section 23a can check a computation circuit loaded in the reconfigurable device 12a by referring to the tag 25a. Similarly, the reconfigurable control section 23a can check a computation circuit loaded in the reconfigurable device 12b by referring to the tag 25b.

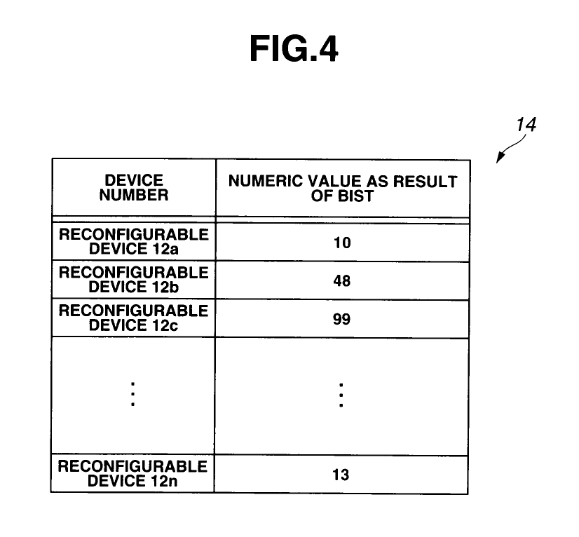

The BIST circuit 26a performs a self-test, i.e., a built-in self-test (BIST), on the reconfigurable device 12a at the time of powering on, for example, to check the operation of the reconfigurable device 12a or measure a numeric value representing an age deterioration, for example, in electrostatic capacity of part of elements of the reconfigurable device 12a. The BIST circuit 26a records the result of the BIST in numeric value form at the corresponding address in the device state storage section 14. Similarly, the BIST circuit 26b performs BIST on the reconfigurable device 12b and records the result of the BIST in numeric value form at the corresponding address in the device state storage section 14. The configuration of the device stage storage section 14 will be described later in detail with reference to FIG. 4.

The configuration of the lock state storage section 13 will be described. FIG. 2 is a diagram for explaining an example of the configuration of the lock state storage section. Description with reference to FIG. 2 will be made by assuming that the multicore processor 1 has a plurality of reconfigurable devices: reconfigurable devices 12a to 12n.

As shown in FIG. 2, 3-bit data corresponding to each of the reconfigurable devices 12a to 12n is stored in the lock state storage section 13. The least significant bit is an on-loading bit indicating whether or not circuit information is being loaded. The second bit is an on-execution bit indicating whether or not a computation is being performed. The most significant bit is a final execution bit indicating whether or not a computation which is being executed is a final computation in a certain sequence of processing.

On-loading bit 0 indicates that circuit information is not being loaded in the corresponding reconfigurable device. On-loading bit 1 indicates that predetermined circuit information is being loaded in the corresponding reconfigurable device.

On-execution bit 0 indicates that the corresponding reconfigurable device is performing no computation. On-execution bit 1 indicates that the corresponding reconfigurable device is performing a predetermined computation.

Final execution bit 0 indicates that the corresponding reconfigurable device is not performing processing for a final computation. Final execution bit 1 indicates that the corresponding reconfigurable device is performing processing for a final computation.

In FIG. 2, it is indicated that predetermined circuit information is being loaded in the reconfigurable device 12a. It is also indicated that the reconfigurable device 12b is executing a predetermined computation. It is also indicated that the reconfigurable device 12c is not occupied by any of the processor cores. Further, it is indicated that the reconfigurable device 12n is executing a predetermined computation, and that the executed computation is a final computation in a certain sequence of processing.

On-loading bit 1 or on-execution bit 1 indicates that the reconfigurable device is occupied by one of the processor cores, that is, the reconfigurable device is locked. For example, in a case where the reconfigurable control section 23a reads out the on-loading bit or the on-execution bit with respect to the reconfigurable device 12a and finds that the read value is 1, the reconfigurable control section 23a can recognize that the reconfigurable device 12a is locked by the other processor core 11b. In this case, the reconfigurable control section 23a reads out the on-loading bit or the on-execution bit for another reconfigurable device 12b. The reconfigurable control section 23a can search for an available one of the reconfigurable devices, i.e., one not locked by the other processor core, as described above, by repeatedly reading out the on-loading bit or the on-execution bit of the reconfigurable device. Thus, each of the on-loading bit and the on-execution bit forms lock information indicating whether or not the corresponding reconfigurable device is locked by one of the processor cores.

When the reconfigurable control section 23a detects an available one of the reconfigurable devices, it writes 1 to the on-loading bit for the available reconfigurable device and loads circuit information. After loading circuit information, the reconfigurable control section 23a writes 0 to the corresponding on-loading bit, writes 1 to the on-execution bit and executes a computation with the reconfigurable device.

Read of data from the on-loading bit or the on-execution bit and write of data to the on-loading bit or the on-execution bit are performed by means of test and setting. Test and setting is an instruction to atomically perform read of data from a certain address and write of data to the address. “Atomic” signifies that no interrupt occurs between read and write under any condition.

If the final execution bit is 1, the computation which is being executed is a final computation in a certain sequence of processing and the reconfigurable device executing can be freed immediately after the completion of the present processing. Therefore, when the final execution bit is 1, the reconfigurable control section 23a can advance loading of circuit information for processing to be next executed in parallel with the present processing. After the completion of the present processing, the reconfigurable control section 23a loads the rest of the circuit information and executes the computation with the reconfigurable device. Identification of a computation as the final computation in a certain sequence of processing is realized by a description in a program. The final execution bit forms final execution information indicating whether or not the corresponding reconfigurable device is performing processing for a final computation.

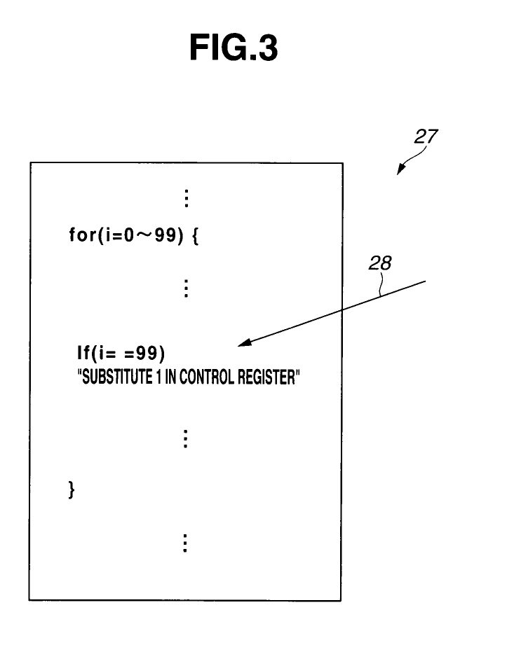

FIG. 3 is a diagram for explaining an example of a program in which processing for setting the final execution bit to 1 is described. As shown in FIG. 3, a program 27 represents a program configured to process including repeating certain processing 100 times. A code indicated by arrow 28 is described in this processing to add a code “Substitute 1 in Control Register” at the time of the 100th repetition of the processing. “1” is thereby substituted in the control register 24a. When 1 is substituted in the control register 24a, the reconfigurable control section 23a performs processing to write 1 to the final execution bit for the corresponding reconfigurable device.

The configuration of the device state storage section 14 will be described. FIG. 4 is a diagram for explaining an example of the configuration of the device state storage section. Description with reference to FIG. 4 will be made by assuming that the multicore processor 1 has a plurality of reconfigurable devices: reconfigurable devices 12a to 12n.

As shown in FIG. 4, device states respectively associated with the reconfigurable devices 12a to 12n are stored in the device state storage section 14. The device states are numeric values respectively obtained from the BIST circuits 26a to 26n. After the completion of the BIST, the processor core 11a reads out the numeric values respectively measured by the BIST circuits 26a to 26n and records the numeric values at the corresponding addresses in the device state storage section 14.

If any of the numeric values exceeds a predetermined threshold value, the processor core 11a records 1 in the on-loading bit or the on-execution bit for the corresponding reconfigurable device in the lock state storage section 13. This means that the reconfigurable device is unusable. Also, it is possible to prevent accidental use of the reconfigurable device by maintaining the reconfigurable device in the locked state. The processor core 11a analyzes the numeric values recorded in the lock state storage section 13 and the device state storage section 14 after the completion of the BIST. If there is an abnormality therein, the processor core 11a can warn a user about the abnormality by using the output device 21. While the description has been made by assuming that the processor core 11a records results of the BIST and analyzes the recorded numeric values, any other processor core may record results of the BIST and analyze the recorded numeric values.

As such, recording of results of the BIST and analysis of the recorded numeric values enable prediction of a fatal malfunction in any of the reconfigurable device and informing a user of an unsafe state before the reconfigurable device is completely broken. While issuing a warning when a predetermined threshold value is exceeded has been described, the arrangement may alternatively be such that results of measurement in the BIST previously made are recorded in a flash memory (not shown); the results of measurement in the BIST presently made and the results of measurement in the BIST previously made recorded in the flash memory are compared with each other; and a warning is issued if the difference between the measurement results is large.

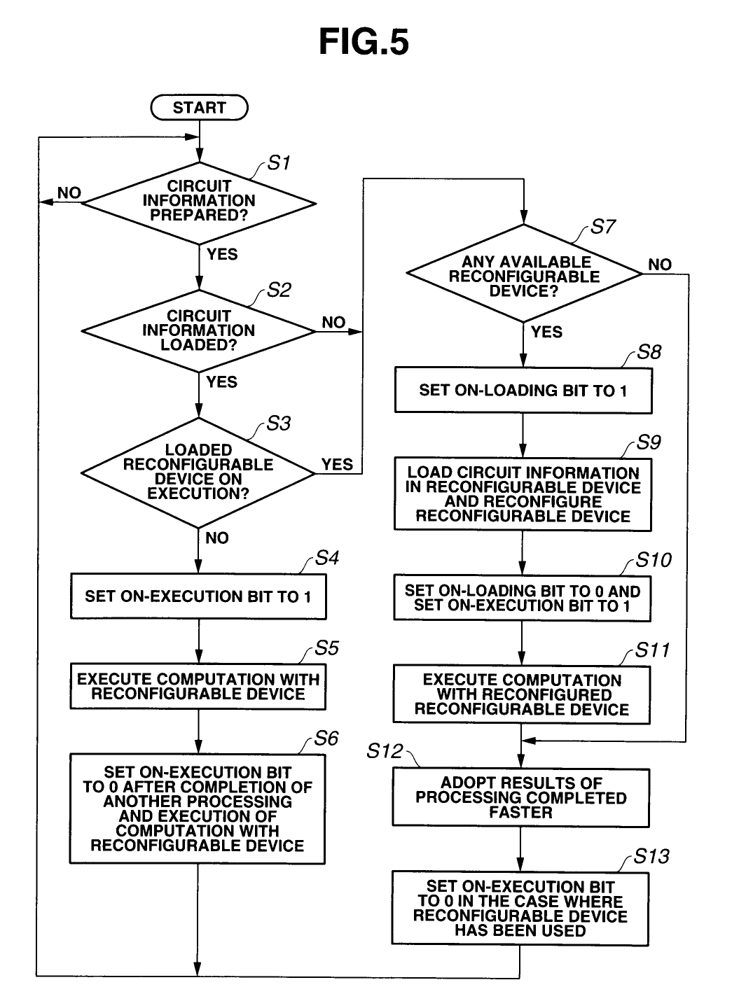

FIG. 5 is a flowchart showing an example of a flow of processing for computations with the reconfigurable devices. This processing is executed by the reconfigurable control section of one of the processor cores when the processor core executes a computation based on a program. Processing executed by the reconfigurable control section 23a of the processor core 11a when the processor core 11a executes a computation based on a program will representatively be described with reference to FIG. 5. Processing shown in FIG. 5 is started when the processor core 11a executes a program, i.e., when the processor core 11a executes software processing. It is assumed that the processor core 11a executes software processing while processing shown in FIG. 5 is being performed.

First, the reconfigurable control section 23a monitors an instruction fetched by the processor core 11a and determines whether or not circuit information for a computation to be executed has been prepared (step S1). If the circuit information for the computation to be executed has not been prepared, the determination result is NO and the process returns to step S1. If the circuit information for the computation to be executed has been prepared, the determination result is YES and the reconfigurable control section 23a determines whether or not the circuit information for the computation to be executed has been loaded in one of the reconfigurable devices (step S2). This processing is executed by the reconfigurable control section 23a referring to the tags 25a and 25b. If the circuit information for the computation to be executed has been loaded, the determination result is YES and the reconfigurable control section 23a determines whether or not the reconfigurable device in which the circuit information for the computation to be executed has been loaded is executing a computation (step S3). This processing is executed by the reconfigurable control section 23a referring to the on-loading bit and the on-execution bit in the lock state storage section 13. If the reconfigurable device is executing no computation, the determination result is NO and the reconfigurable control section 23a sets the on-execution bit for the reconfigurable device to 1 (step S4) and executes hardware processing, i.e., a computation with the reconfigurable device (step S5). Thus, in a case where circuit information for a computation to be executed has been loaded in one of the reconfigurable devices, and where the reconfigurable device is not executing, only the computation with the reconfigurable device is executed. While the computation with the reconfigurable device is being executed, the processor core 11a may perform different software processing. After the completion of the different processing and the execution of the computation with the reconfigurable device, the reconfigurable control section 23a sets the on-execution bit to 0 (step S6), and the process returns to step S1. Then, the reconfigurable control section 23a continues the software processing originally performed.

If in step S2 the circuit information for the computation to be executed has not been loaded or if in step S3 the reconfigurable device is executing a computation, the reconfigurable control section 23a determines whether or not one of the other reconfigurable devices is available (step S7). If one of the other reconfigurable devices is available, the determination result is YES and the reconfigurable control section 23a sets the on-loading bit for the reconfigurable device to 1 (step S8), loads the circuit information for the computation to be executed into the available reconfigurable device, and reconfigures the reconfigurable device (step S9). After the completion of loading of the circuit information for the computation to be executed, the reconfigurable control section 23a sets the on-loading bit and on-execution bit for the load-completed reconfigurable device to 0 and 1, respectively (step S10) and executes the computation with the reconfigured reconfigurable device (step S11). The reconfigurable control section 23a performs the execution of the computation with the processor core 11a and the execution of the computation with the reconfigurable device in parallel with each other and adopts the results of the execution of the computation completed faster in the results of the two executions of the computation performed in parallel with each other (step S12). In the case where the computation with the reconfigurable device is executed, the reconfigurable control section 23a sets the on-execution bit to 0 (step S13) and the process returns to step S1.

If none of the reconfigurable devices is available in step S7, the determination result is NO and the process advances to step S12. In the case where none of the reconfigurable devices is available in step S7, only software processing is performed without performing hardware processing with any of the reconfigurable devices. In step S12, therefore, the results of software processing are always adopted. In step S13, since none of the reconfigurable devices is used, processing for setting the on-execution bit to 0 is not performed.

In the above-described processing, if circuit information for a computation to be executed has been loaded in one of the reconfigurable devices, and if the reconfigurable device is not occupied by the other processor core, the reconfigurable control section executes only the computation with the reconfigurable device, i.e., hardware processing at a high processing speed. On the other hand, in a case where the circuit information for the computation to be executed has not been loaded, or in a case where the circuit information for the computation to be executed has been loaded in one of the reconfigurable devices but the reconfigurable device is executing a computation, the reconfigurable control section 23a performs control for performing software processing and hardware processing including reconfiguration of another of the reconfigurable devices in parallel with each other, and for adopting, as the results of the computation to be executed, the results of the processing completed faster in the two processings performed in parallel with each other. Thus, the results of processing completed faster can be adopted in any situation without determining through which one of software processing and hardware processing the processing can be completed faster as in the conventional art.

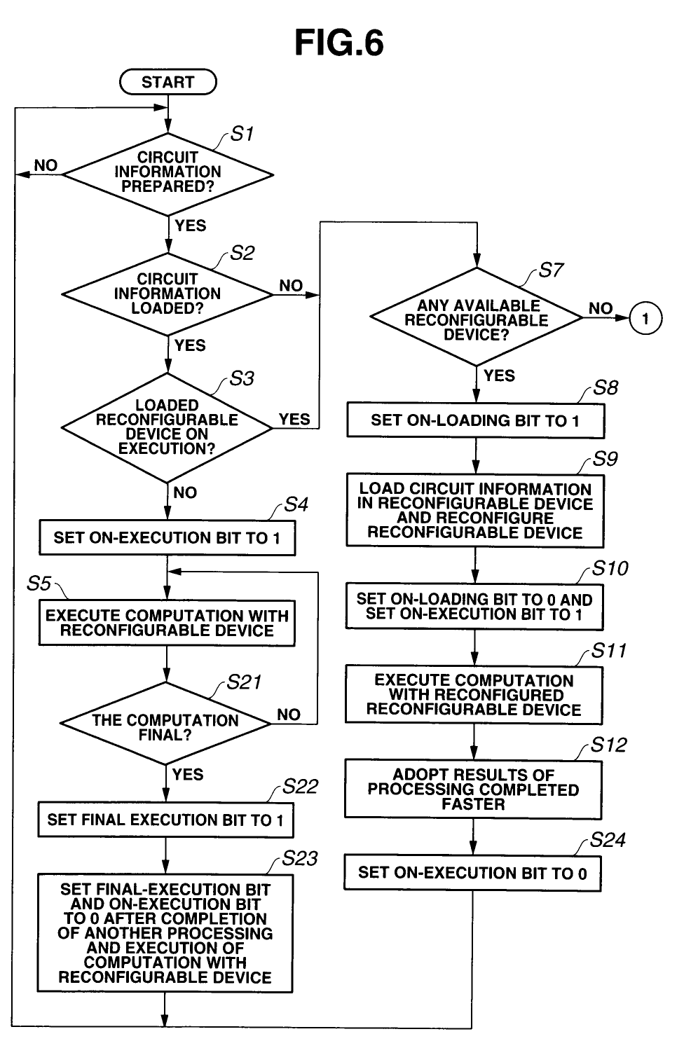

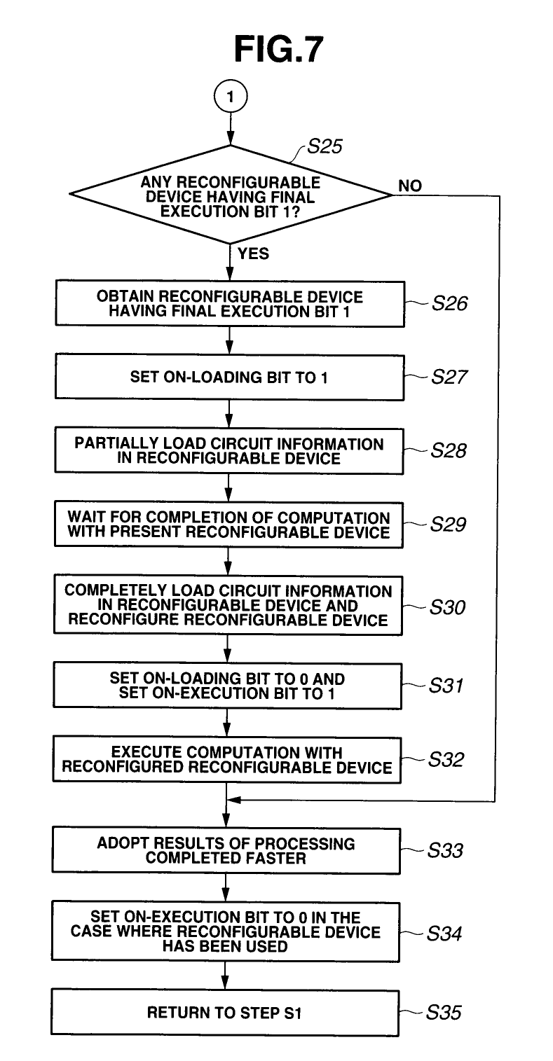

FIGS. 6 and 7 are flowcharts showing an example of a flow of loading of new circuit information in parallel with a computation with one of the reconfigurable devices. In FIG. 6, the same processings as those shown in FIG. 5 are indicated by the same reference characters. The description of the same processings will not be repeated.

In step S5, a computation with one of the reconfigurable devices is executed and detection as to whether the computation is a final one is performed (step S21). If the computation is not a final one, the detection result is NO and the process returns to step S5 to continue computation with the reconfigurable devices. If the computation is a final one, the detection result is YES and the reconfigurable control section 23a sets the final execution bit for the final-computation-executing reconfigurable device to 1 (step S22). After the completion of different processing and the execution of the computation with the reconfigurable device, the reconfigurable control section 23a sets each of the final execution bit and the on-execution bit to 0 (step S23).

If one of the reconfigurable devices is available in step S7, processing from step S8 to step S12 is executed and the on-execution bit is thereafter set to 0 (step S24).

If none of the reconfigurable devices is available in step S7, the process moves to the flow shown in FIG. 7 and the reconfigurable control section 23a determines whether or not there is a final execution bit 1 for one of the reconfigurable devices (step S25). If there is a final execution bit 1 for one of the reconfigurable devices, the determination result is YES and the reconfigurable control section 23a obtains the reconfigurable device with the final execution bit 1 (step S26). The reconfigurable control section 23a sets the on-loading bit to 1 (step S27) and loads part of the circuit information for the computation to be executed in the reconfigurable device (step S28). The reconfigurable control section 23a waits for the completion of the present computation with the reconfigurable device (step S29), completely loads into the reconfigurable device the circuit information for the computation to be executed, and reconfigures the reconfigurable device (step S30). The reconfigurable control section 23a sets the on-loading bit and the on-execution bit to 0 and 1, respectively (step S31) and executes the computation with the reconfigured reconfigurable device, i.e., hardware processing (step S32). The reconfigurable control section 23a adopts the results of one of software processing and hardware processing completed faster (step S33). In the case where the reconfigurable device is used, the reconfigurable control section 23a sets the on-execution bit to 0 (step S34) and the process returns to step S1 (step S35).

If none of the reconfigurable devices is available in step S25, the determination result is NO and the process advances to step S33. In the case where none of the reconfigurable devices is available in step S25, only software processing is performed without performing hardware processing with any of the reconfigurable devices. In step S33, therefore, the results of software processing are always adopted. In step S34, since none of the reconfigurable devices is used, processing for setting the on-execution bit to 0 is not performed.

In the above-described processing, if one of the reconfigurable devices is performing processing for a final computation, the reconfigurable control section 23a loads part of circuit information in the reconfigurable device, and loads the rest of the circuit information after the completion of the present computation. Thus, the reconfigurable devices can be used with efficiency and the effect of reducing the overhead by switching between the low power consumption mode and the normal power consumption mode can also be obtained.

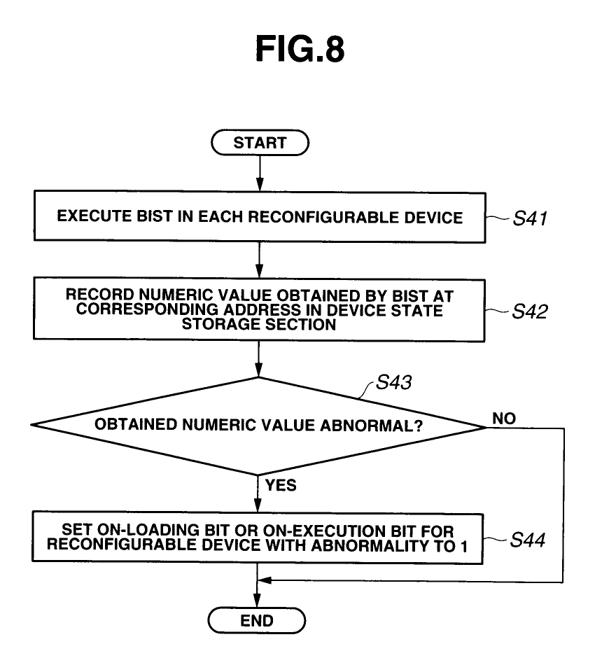

FIG. 8 is a flowchart showing an example of a flow of BIST processing. This BIST processing is started by powering on the multicore processor 1.

First, the BIST circuits 26a and 26b execute the BIST on the corresponding reconfigurable devices 12a and 12b (step S41). Numeric values obtained by the BIST are recorded at corresponding addresses in the device state storage section 14 (step S42). Subsequently, determination is made as to whether or not each of the numeric values obtained in step S42 is abnormal (step S43). If one of the numeric values is determined as abnormal in step S43, the determination result is YES and the on-loading bit or the on-execution bit for the reconfigurable device with an abnormality is set to 1 (step S44), thereby completing the processing. If none of the numeric values is determined as abnormal in step S43, the determination result is NO and the processing ends.

In the above-described processing, if one of the numeric values in the results of the BIST is abnormal, that is, if there is an abnormality in one of the reconfigurable devices, the on-loading bit or the on-execution bit for the reconfigurable device with the abnormality is set to 1 to lock the reconfigurable device with the abnormality. In this way, prohibition of use of one of the reconfigurable devices with an abnormality is enabled. Also, if there is an abnormality, the abnormality may be displayed on the output device 21, e.g., a display device or the like to notify a user of information on the reconfigurable device having the abnormality.

As described above, the multicore processor 1 performs processing with the processor core 11a and processing with the reconfigurable device 12a in parallel with each other and adopts the results of the processing completed faster. As a result, the need for a time taken to select between execution of software processing and execution of hardware processing as in the conventional art is eliminated and the processing speed can be increased.

Thus, in the multicore processor according to the present embodiment, software processing and hardware processing including hardware reconfiguration are executed in parallel with each other and the results of the processing completed faster are adopted, thereby increasing the processing speed.

The order of execution of the steps shown in the flowcharts referred to in this specification may be changed, two or more of the steps may be simultaneously executed, or the order of execution may be changed each time the processing is executed, provided that the way of execution does not disaccord with the characteristics of the steps.

The present invention is not limited to the above-described embodiment. Various changes, modifications, and the like can be made in the described embodiment without departing the gist of the present invention.

What is claimed is:

1. A multicore processor comprising:
a plurality of processor cores each of which is configured to execute a computation based on a program;
a plurality of reconfigurable devices each reconfigurable dynamically in circuit configuration on the basis of circuit information;
a lock state storage section configured to store lock information indicating whether or not each of the reconfigurable devices is locked by one of the plurality of processor cores; and
a plurality of reconfigurable control sections respectively provided in correspondence with the plurality of processor cores, each of the reconfigurable control sections configured to execute: determining whether or not circuit information for a computation to be executed is loaded in each of the reconfigurable devices, and if the circuit information for the computation to be executed is loaded, referring to the lock information and performing only execution of the computation with the reconfigurable device in which the circuit information for the computation to be executed is loaded, without executing the computation to be executed in any of the plurality of processor cores, when the reconfigurable device in which the circuit information for the computation to be executed is loaded is not locked, and if the circuit information for the computation to be executed is not loaded, loading the circuit information for the computation to be executed in one of the reconfigurable devices not locked, by referring to the lock information, performing execution of the computation with the reconfigurable device in which the circuit information for the computation to be executed is loaded and execution of the computation with one of the plurality of processor cores in parallel with each other, and performing control so that results of the execution of the computation completed faster between results of the two executions of the computation performed in parallel with each other are adopted as results of the computation to be executed.

2. The multicore processor according to claim 1, wherein the lock state storage section further stores final execution information indicating whether or not each of the reconfigurable devices is performing processing for a final computation, and
wherein each of the plurality of reconfigurable control sections refers to the final execution information and, if one of the reconfigurable devices is performing processing for the final computation, the reconfigurable control section loads part of the circuit information into the reconfigurable device performing processing for the final computation, loads the rest of the circuit information into the reconfigurable device after the completion of the final computation, and reconfigures the circuit configuration of the reconfigurable device.

3. The multicore processor according to claim 1, wherein each of the plurality of reconfigurable devices has a register configured to hold loaded circuit information, and
wherein each of the plurality of reconfigurable control sections determines, by referring to the register, whether or not the circuit information for the computation to be executed is loaded in each of the reconfigurable devices.

4. The multicore processor according to claim 1, wherein when loading the circuit information, each of the reconfigurable control sections changes the reconfigurable device into which the circuit information is loaded from a low power consumption mode to a normal power consumption mode.

5. The multicore processor according to claim 1, wherein when loading the circuit information for the computation to be executed into the reconfigurable device not locked, each of the plurality of reconfigurable control sections changes the lock information on the reconfigurable device into which the circuit information for the computation to be executed is loaded into lock information indicating that the reconfigurable device is locked by one of the plurality of processor cores.

6. The multicore processor according to claim 1, wherein if all of the reconfigurable devices are locked as a result of reference to the lock information, the computation to be executed is executed in one of the plurality of processor cores.

7. The multicore processor according to claim 1, wherein the lock information includes information formed of an on-loading bit indicating whether or not the circuit information for the computation to be executed is being loaded into each of the reconfigurable devices, and information formed of an on-execution bit indicating whether or not each of the reconfigurable devices is executing the computation to be executed.

8. The multicore processor according to claim 1, further comprising:
a plurality of BIST circuits respectively provided in correspondence with the plurality of reconfigurable devices, each of the BIST circuits configured to perform a self-test on the corresponding reconfigurable device; and
a device state storage section configured to store results of the self-tests performed by the plurality of BIST circuits,
wherein each of the plurality of BIST circuits stores the result of the self-test in the device state storage section, and
wherein if an abnormality exists in the results of the self-tests stored in the device state storage section, one of the plurality of processor cores locks the reconfigurable device having the abnormality.

9. The multicore processor according to claim 8, wherein one of the plurality of processor cores locks the reconfigurable device having the abnormality by changing the lock information on the reconfigurable device having the abnormality into lock information indicating that the reconfigurable device is locked by one of the plurality of processor cores.

10. The multicore processor according to claim 8, wherein one of the plurality of processor cores displays information on the reconfigurable device having the abnormality on a display device.

11. A method of controlling a multicore processor, comprising:
storing lock information indicating whether or not each of a plurality of reconfigurable devices reconfigurable dynamically in circuit configuration on the basis of circuit information is locked by one of a plurality of processor cores each of which is configured to execute a computation based on a program;
determining whether or not circuit information for a computation to be executed is loaded in each of the reconfigurable devices;
if the circuit information for the computation to be executed is loaded, referring to the lock information, and performing only execution of the computation with the reconfigurable device in which the circuit information for the computation to be executed is loaded, without executing the computation to be executed in any of the plurality of processor cores, when the reconfigurable device in which the circuit information for the computation to be executed is loaded is not locked; and
if the circuit information for the computation to be executed is not loaded, loading the circuit information for the computation to be executed in one of the reconfigurable devices not locked, by referring to the lock information, performing execution of the computation with the reconfigurable device in which the circuit information for the computation to be executed is loaded and execution of the computation with one of the plurality of processor cores in parallel with each other, and performing control so that results of the execution of the computation completed faster between results of the two executions of the computation performed in parallel with each other are adopted as results of the computation to be executed.

12. The method of controlling a multicore processor according to claim 11, wherein final execution information indicating whether or not each of the reconfigurable devices is performing processing for a final computation is further stored, and
wherein the final execution information is referred to; if one of the reconfigurable devices is performing processing for the final computation, part of the circuit information is loaded into the reconfigurable device performing processing for the final computation; the rest of the circuit information is loaded into the reconfigurable device after the completion of the final computation; and the circuit configuration of the reconfigurable device is reconfigured.

13. The method of controlling a multicore processor according to claim 11, wherein the loaded circuit information is held, and
wherein determination is made by referring to the circuit information held as to whether or not the circuit information for the computation to be executed is loaded in each of the reconfigurable devices.

14. The method of controlling a multicore processor according to claim 11, wherein when the circuit information is loaded, the reconfigurable device into which the circuit information is loaded is changed from a low power consumption mode to a normal power consumption mode.

15. The method of controlling a multicore processor according to claim 11, wherein the circuit information for the computation to be executed is loaded into the reconfigurable device not locked, the lock information on the reconfigurable device into which the circuit information for the computation to be executed is loaded is changed into lock information indicating that the reconfigurable device is locked by one of the plurality of processor cores.

16. The method of controlling a multicore processor according to claim 11, wherein if all of the reconfigurable devices are locked as a result of reference to the lock information, the computation to be executed is executed in one of the plurality of processor cores.

17. The method of controlling a multicore processor according to claim 11, wherein the lock information includes information formed of an on-loading bit indicating whether or not the circuit information for the computation to be executed is being loaded into each of the reconfigurable devices, and information formed of an on-execution bit indicating whether or not each of the reconfigurable devices is executing the computation to be executed.

18. The method of controlling a multicore processor according to claim 11, wherein a self-test is performed on each of the plurality of reconfigurable devices;
results of the self-test are stored; and
if an abnormality exists in the stored results of the self-test, the reconfigurable device having the abnormality is locked.

19. The method of controlling a multicore processor according to claim 18, wherein the reconfigurable device having the abnormality is locked by changing the lock information on the reconfigurable device having the abnormality into lock information indicating that the reconfigurable device is locked by one of the plurality of processor cores.

20. The method of controlling a multicore processor according to claim 18, wherein information on the reconfigurable device having the abnormality is displayed on a display device.
